(19) United States
(12) Patent Application Publication
(10) Pub. No.: US 2006/0291187 A1
(43) Pub. Date: Dec. 28, 2006

(54) Illuminated sign

(76) Inventor: Fu-Kuo Huang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/329,285

(22) Filed: Jan. 11, 2006

(30) Foreign Application Priority Data
Jun. 13, 2005 (TW) 094119526

(51) Int. Cl. F21V 9/16

(52) U.S. Cl. 362/84

(57) ABSTRACT

An illuminated sign is disclosed. By a photoluminescent and marking layer that absorbs light, the illuminated sign stores light energy and emits light spontaneously for making an icon on the f photoluminescent and marking layer visible. The light is generated from a light emitting module that couples to a power supply module for getting power. The photoluminescent and marking layer is disposed on a substrate. Moreover, the device can also emit light by a photoluminescent layer that receives light from the light emitting module and stores the light energy so as to illuminate the icon on a marking layer over the photoluminescent layer.

### BACKGROUND OF THE INVENTION

The present invention relates to a sing, especially to an illuminated sign that stores light energy, makes icons thereon visible and efficiently saves the power.

Signs such as traffic signs, guideboards, doorplates, and bus stops use paint coated on signs such as figures or words on iron or wood plates. Or the signs are written on paper and then attached on iron or wood plates to form signboards. When there is no sunlight, illumination devices connected with external power sources are used to light the signs. In out-country area, it's difficult for illumination devices to connect with external power sources. Thus the signs are not clearly visible. Or the distance between the illumination devices and the sign boards is too far, it's difficult to discern the signs in time. Moreover, the view of traffic signs or devices may be interfered with, be confused with, or obstructed by the landform or positions due to large distance therebetween or direction of emitting. Even there are illumination devices, once drivers can't see the icons on traffic signs clearly, they will have trouble identifying traffic and road conditions. Furthermore, the illumination devices working for a long period of time consume large amount of power.

In addition, signboards set by shops need to connect with illumination devices as external light sources to make the icons on the signboards visible when there is no sunlight or other natural light source. This increases the cost for electricity. However, in recent years, due to rising consciousness of environment protection, how to save energy for lighting has become an important issue.

In order to improve above disadvantages, the present invention provides an illuminated sign that not only improves the obstructed view of traffic signs caused by the landform or positions but also reduces power consumed by illumination devices as well as electricity cost for environmental protection.

### SUMMARY OF THE INVENTION

Therefore, it is a primary object of the present invention to provide an illuminated sign that stores light energy to make the icon thereof visible. Thus there is no need to consume power for a long period and the electricity is saved.

It is another object of the present invention to provide an illuminated sign that includes a power supply module to supply power periodically for lighting icons on the device so as to save electricity.

It is a further object of the present invention to provide an illuminated sign that makes icons thereof visible without connection of external illumination devices so that the device is disposed somewhere easily and conveniently.

An illuminated sign according to the present invention consists of a photoluminescent and marking layer, a substrate, a light emitting module and a power supply module. The photoluminescent and marking layer is disposed on the substrate and is able to absorb light from the light emitting module, stores the energy and illuminate spontaneously for making an icon thereon more visible. The power supply module couples to and provides power to the light emitting module for generating light.

Moreover, the present invention further provides an illuminated sign having a marking layer, a photoluminescent layer, a light emitting module and a power supply module. The photoluminescent layer is able to absorb light from the light emitting module, stores the energy and illuminate spontaneously for making an icon on the marking layer over the photoluminescent layer more visible. The power supply module couples to and provides power to the light emitting module for generating light.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front view of an embodiment in accordance with the present invention;

FIG. 2 is a front view of another embodiment in accordance with the present invention;

FIG. 3 is a side view of a further embodiment in accordance with the present invention;

FIG. 4 is a side view of a further embodiment in accordance with the present invention; and

FIG. 5 is a front view of a further embodiment in accordance with the present invention.

### DETAILED DESCRIPTION OF THE PREFFERED EMBODIMENT

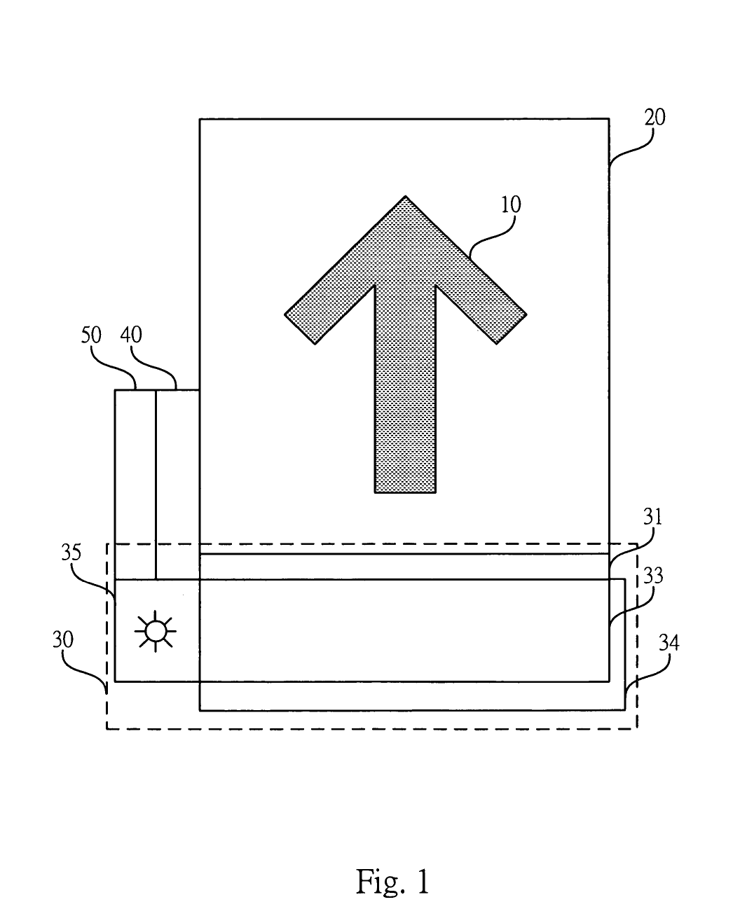

Refer to FIG. 1, the present invention consists of a photoluminescent and marking layer 10 disposed on a substrate 20, a light emitting module 30 arranged on the substrate 20 as a light source to generate light, and a power supply module 40 coupled to and providing power to the light emitting module 30. The photoluminescent and marking layer 10 includes a photoluminescent powder with the function of absorbing light. The powder is characterized by light absorption, saving and emitting for making figures or words of signs on the photoluminescent and marking layer 10 visible. In order to prevent the photoluminescent powder from being affected by external factors such as humidity, each granule of the photoluminescent powder is coated with a transparent ceramic.

When there is no natural light source such as sunlight for the photoluminescent and marking layer 10 to absorb, the light-emitting module 30 provides light to the photoluminescent and marking layer 10 by getting power from the power-supply module 40. Thus even there is no sunlight, the device still can emit light to light up the icons. Because that the photoluminescent powder can illuminate for quite a long time consecutively after only a short period of light absorption, the light-emitting module 30 just needs to generate light at a long interval. That means the power supply module 40 doesn't provide electricity for a long time so that the power is saved. Therefore, there is no need of external power source for providing the light-emitting module 30 electricity, only the power supply module 40 is needed. The power supply module 40 can be a solar power supply module or a solar battery. Moreover, the power supply module 40 is coupled to a control unit 50 for making the power-supply module 40 transmitting power to the light-emitting module 30 at a certain interval.

In this embodiment, the icons are formed by painting the photoluminescent powder on an opaque substrate 20 or coating the photoluminescent powder on stickers that attach on the opaque substrate 20. The light-emitting module 30 according to the present invention is an edge lighting type backlight module composed of a diffusion layer 31, a light guide plate 33, a reflective layer 34 and at least one light source 35. The diffusion layer 31 is arranged on one side of the substrate 20, the light guide plate 33 is disposed on a side of the diffusion layer 31, while the light source 35 is set on one end of the light guide plate 33 and the reflective layer 34 is arranged on one end and one side of the light guide plate 33.

When the control unit 50 makes the power supply module 40 send power to the light source 35, light from the light source 35 emits to the light guide plate 33 that is used to guide the received light in a certain direction. Then the light passes through the diffusion layer 31 to create uniform light dispersed over the photoluminescent and marking layer 10 for homogeneous light absorption. The reflective layer 34 is for reflecting light from the light source 35. For more efficient reflection of light, the reflective layer 34 can be disposed on the circumference of the light source 35, the diffusion layer 31 and the substrate 20. After a period of time, the control unit 50 makes the power supply module 40 stop transmitting power to the light source 35. At the moment, the photoluminescent and marking layer 10 spontaneously emits light for lighting up the icons marked on devices. The diffusion layer 31 between the substrate 20 and the light guide plate 33 can be left out.

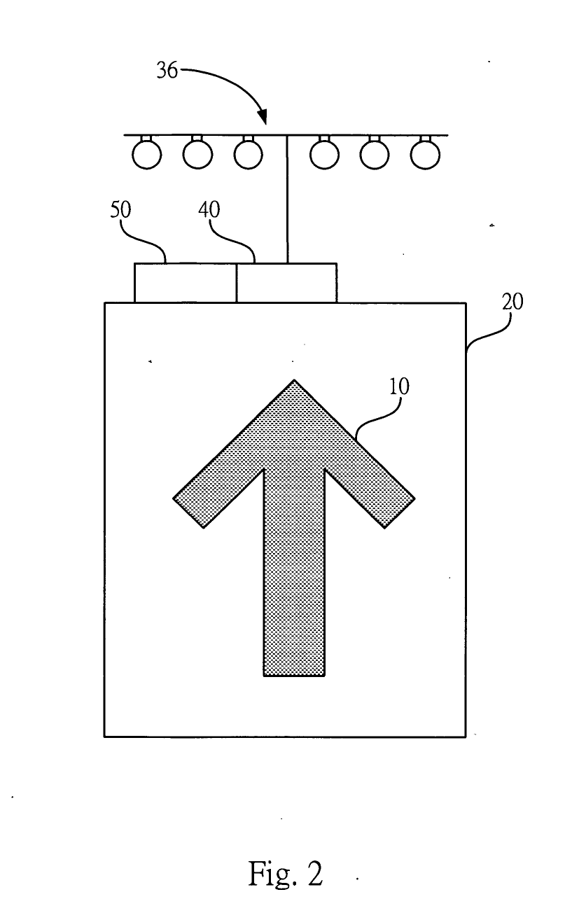

Refer to FIG. 2, when the substrate 20 is opaque, the light-emitting module 30 can be an external incident light source such as light bulbs for providing the photoluminescent and marking layer 10 light.

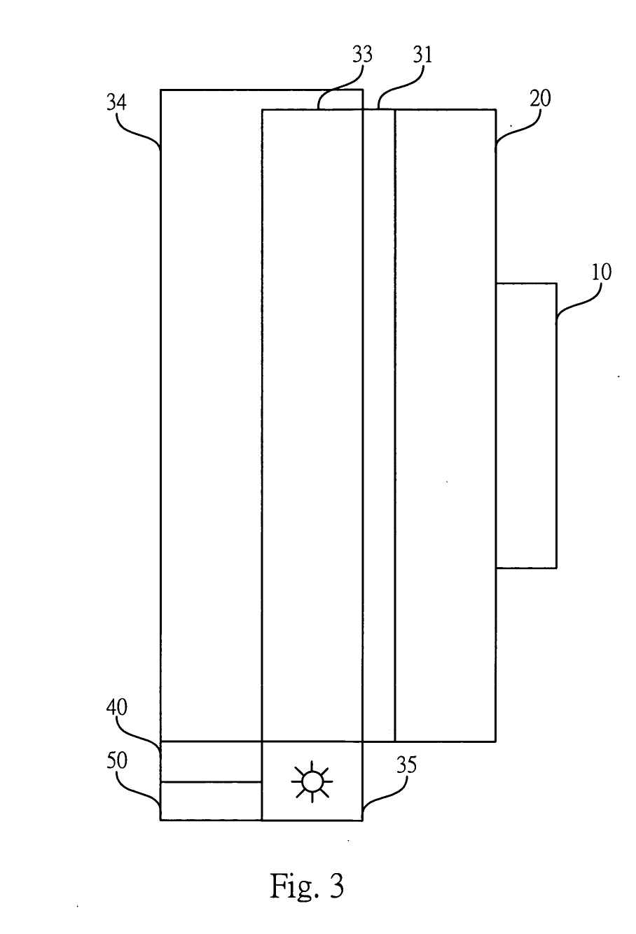

With reference of FIG. 3, when part of the substrate 20 that corresponds to the position of the icons on the photoluminescent and marking layer 10 is transparent while the rest part is opaque, as shown in figure, the light-emitting module 30 is an edge lighting backlight module. The difference between this embodiment and the embodiment in FIG. 1 is in that the diffusion layer 31 and the light guide plate 33 are both arranged on one side of the substrate 20 so that the light guide plate 33 makes the light from the light source 35 achieve the transparent part of the substrate 20 and then the photoluminescent and marking layer 10 absorbs the light, stores the energy to make the icons visible.

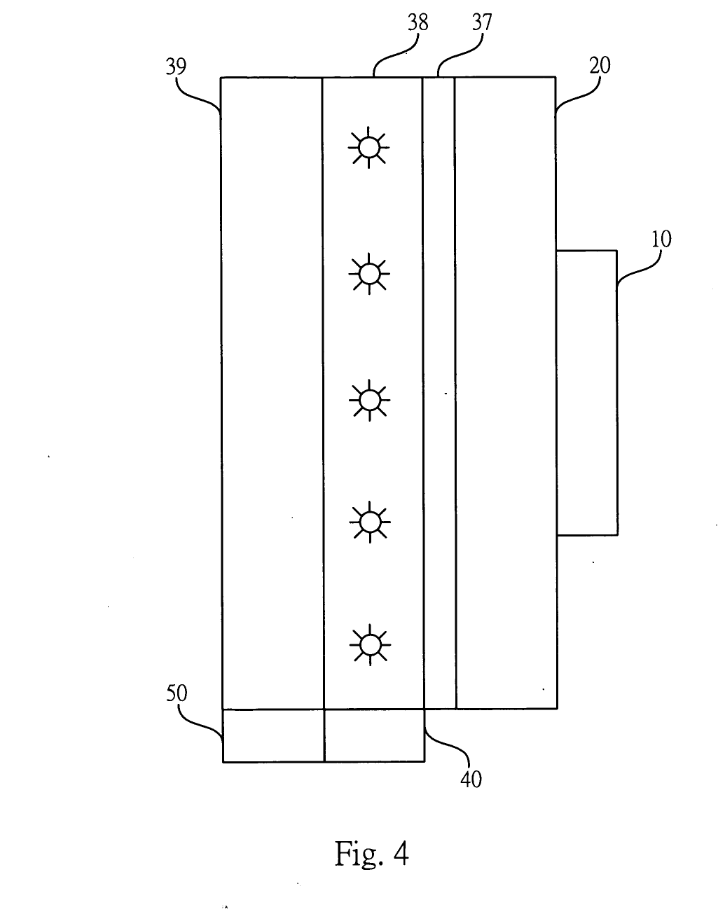

Refer to FIG. 4, the difference between this embodiment and above one is in that the light-emitting module 30 is bottom lighting type, composed by a diffusion layer 37, at least one light source 38, and a reflective layer 39. The diffusion layer 37 is on one side of the substrate 20 while the light source 38 is arranged on one side of the diffusion layer 37. And the reflective layer 39 is on one side of the light source 38 so as to prevent light from the light source 38 from spreading out. In order to increase light reflection efficiency, the reflective layer 39 is further disposed on the circumference of the diffusion layer 37, the light source 38, and the substrate 20. The substrate 20 of this embodiment is the same with that of the embodiment in FIG. 3—part of the substrate 20 that corresponds to the position of the icons on the photoluminescent and marking layer 10 is transparent while the rest part is opaque. When the control unit 50 drives the light source 38 to emit light, the light passes through the diffusion layer 37, dispersed homogeneously over the transparent area of the substrate 20, then emits to the photoluminescent and marking layer 10. Thus the photoluminescent powder absorbs light and saves energy for spontaneously emitting light when there is no light from the surrounding environment.

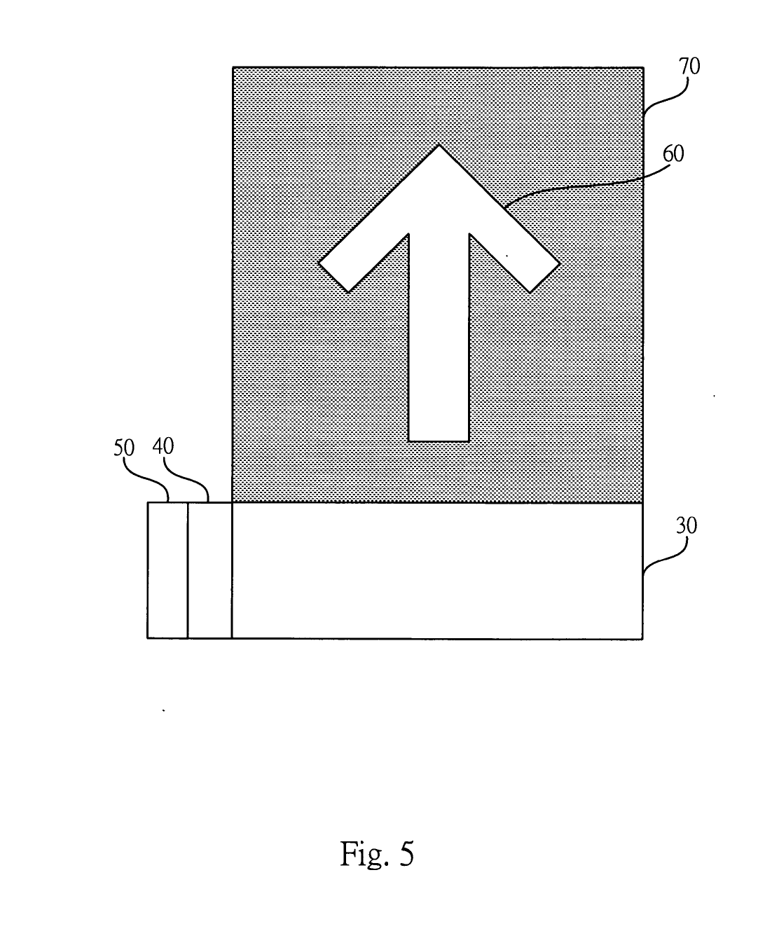

Refer to FIG. 5, the present invention includes a marking layer 60 arranged on a photoluminescent layer 70 while the marking layer 60 having an opaque icon and the photoluminescent layer 70 having photoluminescent powder that absorbs light for spontaneously emitting light. When the light-emitting module 30 generates light, the photoluminescent layer 70 absorbs light and emits light spontaneously. Thus there is a contrast between the opaque icon on the marking layer 60 and the illuminated photoluminescent layer 70. The icon is seen clearly. The light-emitting module 30 in this embodiment is the same with that of the embodiment in FIG. 1, both are edge lighting type backlight modules. Because the photoluminescent layer 70 in this embodiment is transparent, the light-emitting module 30 of this embodiment can be either the edge lighting type in FIG. 3 or the bottom lighting type in FIG. 4.

In summary, an illuminated sign in accordance with the present invention uses a power supply module to provide the light-emitting module power periodically so that the photoluminescent and marking layer or the photoluminescent layer can absorb light for spontaneously emitting light to show the icon clearly when there is no natural light source. Due to discontinuously power supply, the energy is efficiently saved. It is unnecessary for the present invention to connect with external power source because there is an internal power supply module. Therefore, there is no limitation on positions of setting the present invention and the icon is seen clearly.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An illuminated sign comprising:
a substrate;
a photoluminescent and marking layer with an icon thereon disposed on one side of the substrate;
a light emitting module for providing light to the photoluminescent and marking layer so that the photoluminescent and marking layer stores light energy and makes the icon visible; and
a power supply module coupled to and providing power to the light emitting module.

2. The device as claimed in claim 1, wherein the substrate is an opaque substrate.

3. The device as claimed in claim 1, wherein part of the substrate that corresponds to the position of the icon on the photoluminescent and marking layer is transparent while the rest part is opaque.

4. The device as claimed in claim 1, wherein the icon on the photoluminescent and marking layer having photoluminescent powder.

5. The device as claimed in claim 4, wherein each granule of the photoluminescent powder is coated with ceramic.

6. The device as claimed in claim 1, wherein the light emitting module is an edge lighting type backlight module.

7. The device as claimed in claim 6, wherein the edge lighting type backlight module comprising:
a light guide plate disposed on edge of the substrate;
at least one light source arranged on one end of the light guide plate; and
a reflective layer arranged on one end and one side of the light guide plate.

8. The device as claimed in claim 7, wherein a diffusion layer is disposed between the light guide plate and the substrate.

9. The device as claimed in claim 6, wherein the edge lighting type backlight module comprising:
a light guide plate disposed on one side of the substrate;
at least one light source arranged on one end of the light guide plate; and
a reflective layer arranged on one end and one side of the light guide plate.

10. The device as claimed in claim 9, wherein a diffusion layer is disposed between the light guide plate and the substrate.

11. The device as claimed in claim 1, wherein the light emitting module is a bottom lighting type backlight module.

12. The device as claimed in claim 11, wherein the bottom lighting type backlight module comprising:
at least one light source arranged on one side of the substrate; and
a reflective layer disposed on one side of the light source.

13. The device as claimed in claim 12, wherein a diffusion layer is disposed between the light source and the substrate.

14. The device as claimed in claim 1, wherein the power supply module is coupled to a control unit for making the power-supply module transmitting power to the light-emitting module.

15. The device as claimed in claim 1, wherein the power supply module is a solar power supply module.

16. An illuminated sign comprising:
a photoluminescent layer;
a marking layer having an icon arranged on one side of the photoluminescent layer;
a light emitting module for providing light to the photoluminescent layer so that the photoluminescent layer stores light energy and makes the icon visible; and
a power supply module coupled to and providing power to the light emitting module.

17. The device as claimed in claim 16, wherein the marking layer is opaque while the photoluminescent layer is transparent.

18. The device as claimed in claim 16, wherein the photoluminescent layer having photoluminescent powder.

19. The device as claimed in claim 18, wherein each granule of the photoluminescent powder is coated with ceramic.

20. The device as claimed in claim 16, wherein the light emitting module is an edge lighting type backlight module.

21. The device as claimed in claim 20, wherein the edge lighting type backlight module comprising:
a light guide plate disposed on edge of the photoluminescent layer;
at least one light source arranged on one end of the light guide plate; and
a reflective layer arranged on one end and one side of the light guide plate.

22. The device as claimed in claim 21, wherein a diffusion layer is disposed between the light guide plate and the photoluminescent layer.

23. The device as claimed in claim 20, wherein the edge lighting type backlight module comprising:
a light guide plate disposed on one side of the photoluminescent layer;
at least one light source arranged on one end of the light guide plate; and
a reflective layer arranged on one end and one side of the light guide plate.

24. The device as claimed in claim 23, wherein a diffusion layer is disposed between the light guide plate and the photoluminescent layer.

25. The device as claimed in claim 16, wherein the light emitting module is a bottom lighting type backlight module.

26. The device as claimed in claim 25, wherein the bottom lighting type backlight module comprising:
at least one light source arranged on one side of the photoluminescent layer; and
a reflective layer disposed on one side of the light source.

27. The device as claimed in claim 26, wherein a diffusion layer is disposed between the light source and the photoluminescent layer.

28. The device as claimed in claim 16, wherein the power supply module is coupled to a control unit for making the power-supply module transmitting power to the light-emitting module.

29. The device as claimed in claim 16, wherein the power supply module is a solar power supply module.
